(19) United States
(12) Patent Application Publication
(10) Pub. No.: US 2004/0025531 A1
(43) Pub. Date: Feb. 12, 2004

(54) Insulated cooler having integral seat

(76) Inventors: Ronna A. Holloman-Hughes, Kansas City, MO (US); John M. Hughes JR., Kansas City, MO (US)

Correspondence Address: THOMAS B LUEBBERING, HOVEY WILLIAMS LLP, 2405 Grand, Suite 400, Kansas City, MO, 64108, US

(21) Appl. No.: 10/215,627

(22) Filed: Aug. 8, 2002

(51) Int. Cl. B62B 1/00; B62B 3/00; F25D 3/08

(52) U.S. Cl. 62/457.7; 280/47.34; 280/47.26

(57) ABSTRACT

An insulated cooler (10) incorporating a variety of advantageous features, including, for example, one or more integral seats (11), which provide generally enhanced functionality. A preferred embodiment of the cooler (10) broadly comprises a cooler body (12); a cooler lid (14); a backrest (16); two or more wheels (18); and a handle (20). An ergonomically contoured cavity (26) in the lid combines and cooperates with the backrest (16) to provide the integral seat (11). Other features include one or more safety reflectors (23) for reflecting light in low light conditions, and one or more elastically expandable pouches (24) for receiving and retaining items.

### BACKGROUND OF THE INVENTION

1. Field of the Invention

The present invention relates to insulated coolers and similar devices for receiving and maintaining food and drink items at a temperature which is cooler or warmer than that of an ambient environment. More particularly, the present invention concerns an insulated cooler having a lid presenting a contoured concavity and a backrest adapted to combine and cooperate to form an integral seat, wherein the backrest is hinged to fold down for convenient storage and transport, the insulated cooler also including two or more wheels to facilitate pulling or pushing the cooler with a person seated in the integral seat.

2. Description of the Prior Art

Insulated coolers and similar devices for receiving and maintaining food and drink items at a temperature which is cooler or warmer than that of an ambient environment are well-known in the prior art. Because prior art coolers are often used in situations where maximum functionality is desireable, it is also known to sit upon or set things upon them. Unfortunately, prior art coolers are typically not well-adapted for such uses, and can be uncomfortable or can structurally fail under the additional weight and other forces resulting from such uses. Furthermore, though an adult may be able to maintain his or her balance while seated on an unaccommodating prior art cooler, a child may not. Additionally, whereas prior art coolers are typically portable in nature, with many having, for example, carrying handles, they are not conveniently portable while being sat upon. Additionally, where prior art coolers are provided with wheels, they are typically not designed to comfortably or safely accommodate a seated rider.

The limited functionality of prior art coolers can lead to substantial inefficiencies and inconveniences where, for example, a person on an extended outing with a child may be forced to both push a stroller or buggy and carry a cooler.

Due to the above-identified problems and disadvantages in the art, there exists a distinct need for an improved cooler with enhanced functionality.

### SUMMARY OF THE INVENTION

The present invention solves the above-described and other problems and disadvantages in the prior art to provide an insulated cooler incorporating a variety of advantageous features, including, for example, one or more integral seats, which provide generally enhanced functionality. A preferred embodiment of the cooler broadly comprises a cooler body; a cooler lid; a backrest; two or more wheels; and a handle.

The cooler body is conventionally adapted to provide an insulated compartment for receiving items, such as, for example food or drink items, and to maintain those items at a relatively cool or warm temperature for an extended period of time. The body may be structurally reinforced better support a child or adult seated on the integral seat. Such reinforcement may take the form of a plurality of reinforcing ribs incorporated into the body's design.

One or more safety reflectors, adapted to reflect ambient light, may be secured to one or more of the sides of the body, thereby making the cooler safer to use, particularly in low light conditions. Additionally, one or more elastically expandable pouches, adapted for receiving and retaining one or more items, may be secured to one or more of the sides of the body.

The cooler lid is adapted to cooperate with the body so as to substantially complete and seal the insulated compartment. Furthermore, the lid may be hingedly or otherwise movably coupled with the body or may be completely separable therefrom to allow for selectively accessing and sealing the compartment. The lid may be structurally reinforced similar to the body. The lid presents an upper surface having a concavity which provides a bottom or seat portion of the integral seat. The concavity is preferably appropriately ergonomically contoured to more comfortably support the seated user.

The backrest is adapted to provide an upper or backrest portion of the integral seat and to combine and cooperate with the concavity in the lid to substantially complete the integral seat. The backrest may be hingedly or otherwise movably coupled with or completely separable from the upper surface of the lid adjacent to the concavity.

A safety belt, adapted to secure the user sitting in the integral seat, may be attached to the lid or to the backrest, thereby making the integral seat safer to use, particularly for children. The safety belt may be adjustable and, as desired, retractable.

The two or more wheels are physically associated with and adapted to support the body and to allow for wheeled movement of the cooler. To facilitate storage and transportation of the cooler, the wheels may be pivotably coupled with body so as to be positionable in a first wheel position wherein the wheels project below and support the body, and a second wheel position wherein the wheels do not project below and do not support the body. Alternatively, the wheels may be completely separable from the body for efficient storage and transportation.

The handle is coupled with the body and adapted to facilitate pulling and steering the wheeled cooler. The handle may be substantially S-shaped, having a lower portion adapted to removably couple with the body to facilitate storage and transportation, and an upper portion positioned at a comfortable height for gripping and pulling or pushing. Where the cooler includes only two wheels, the lower portion of the handle may include a downwardly projecting leg adapted to rest upon the ground or other surface beneath the cooler when the cooler s not being moved or otherwise supported by a person, thereby substantially increasing the cooler's stability when at rest. The upper portion of the handle 20 may be telescopically adjustable in order to facilitate achieving the comfortable height.

Thus, it will be appreciated that the cooler of the present invention provides a number of substantial advantages over the prior art, including, for example, providing one or more integral seats adapted to comfortably and safely accommodate a child or adult, wherein such adaptation includes structural and ergonomic enhancements which make the cooler more comfortable and safer to sit upon than prior art coolers. Furthermore, the cooler includes two or more wheels which allow it to retain its portable nature even while being sat upon. Additionally, certain components of the cooler can be removable, collapsible, or otherwise stowable to facilitate convenient storage and transport of the cooler. Additionally, the cooler includes safety reflectors which advantageously enhance safety, particularly during evening or other low-light use. Additionally, the cooler includes one or more elastically expandable pouches adapted to conveniently receive and store items in close association with the cooler.

These and other important features of the present invention are more fully described in the section titled DETAILED DESCRIPTION OF A PREFERRED EMBODIMENT, below.

### BRIEF DESCRIPTION OF THE DRAWINGS

A preferred embodiment of the present invention is described in detail below with reference to the attached drawing figures, wherein:

FIG. 1 is an isometric view of a preferred first embodiment of the insulated cooler of the present invention;

FIG. 2 is a fragmentary view showing positioning and movement of a wheel component of the insulated cooler of FIG. 1;

FIG. 3 is a left side plan view of a preferred second embodiment of the insulated cooler of the present invention; and

FIG. 4 is a left side plan view of a preferred third embodiment of the insulated cooler of the present invention.

### DETAILED DESCRIPTION OF A PREFERRED EMBODIMENT

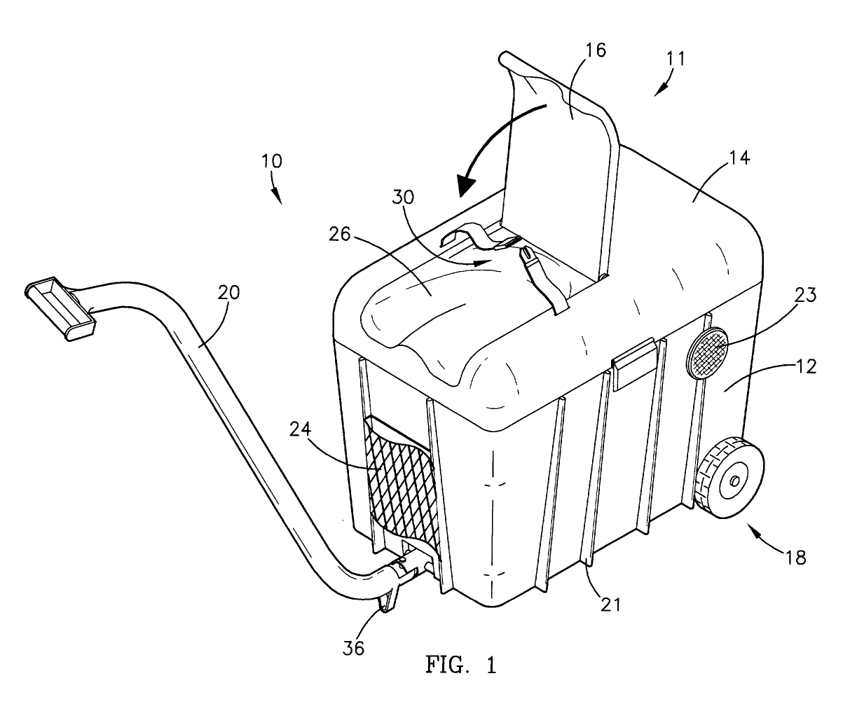

Referring to FIG. 1, an insulated cooler 10 is shown constructed in accordance with a preferred first embodiment of the present invention. The cooler 10 incorporates a variety of advantageous features, including, for example, one or more integral seats 11, which provide generally enhanced functionality. As illustrated, the preferred first embodiment of the cooler 10 broadly comprises a cooler body 12; a cooler lid 14; a backrest 16; two or more wheels 18; and a handle 20.

The cooler body 12 is conventionally adapted to provide an insulated compartment for receiving items, such as, for example food or drink items, and to maintain those items at a relatively cool or warm temperature for an extended period of time. Though illustrated as being substantially rectangular in shape and having four sides, the body 12 may have any suitable and practical alternative dimensions and general shape, and may be constructed using substantially conventional materials, including conventional insulative materials. It will be appreciated that it may be necessary or desirable to structurally reinforce the body 12 to better support a child or adult seated on the integral seat 11. Such reinforcement may take the form of a plurality of reinforcing ribs 21 incorporated into the body's design.

One or more safety reflectors 23, adapted to reflect ambient light, may be secured to one or more of the sides of the body 12, thereby making the cooler 10 safer to use, particularly in low light conditions.

Additionally, one or more elastically expandable pouches 24, adapted for receiving and retaining one or more items, may be secured to one or more of the sides of the body 12. The pouches 24 may be embodied in, for example, substantially conventional elastic net or mesh pouches adapted for remaining substantially flush or tight with the side of the body 12 when unloaded, and for expanding as needed to receive the items.

The cooler lid 14 is adapted to cooperate with the body 12 so as to substantially complete and seal the insulated compartment. Though illustrated as being substantial rectangular in shape, the lid 14 may have any suitable and practical dimensions and general shape, and may be constructed using substantially conventional materials, including conventional insulative materials. Furthermore, the lid 14 may be hingedly or otherwise movably coupled with the body 12 or may be completely separable therefrom to allow for selectively accessing and sealing the compartment. It will be appreciated that it may be necessary or desirable to structurally reinforce the lid 14, similar to the body 12, to better support the child or adult seated on the integral seat 11. The lid 14 presents an upper surface having a concavity 26 which provides a bottom or seat portion of the integral seat 11. The concavity 26 is preferably appropriately ergonomically contoured to more comfortably support the seated user.

The backrest 16 is adapted to provide an upper or backrest portion of the integral seat 11 and to combine and cooperate with the concavity 26 in the lid 14 to substantially complete the integral seat 11. The backrest 16 may be movably coupled with or completely separable from the upper surface of the lid 14 adjacent to the concavity 26. As illustrated, for example, the backrest 16 is hingedly coupled with the upper surface of the lid 14 so as to be positionable in a first seat position wherein the backrest 16 is at least perpendicular to the upper surface of the lid 14, and a second seat position wherein the backrest 16 is substantially parallel to the upper surface of the lid 14. Furthermore, to facilitate storage and transportation, in the aforementioned second seat position at least a portion of the backrest 16 is received within the concavity 26, thereby presenting a more flush and compact configuration.

A safety belt 30, adapted to secure the user sitting in the integral seat 11, may be attached to the lid 14 or to the backrest 16, thereby making the integral seat 11 safer to use, particularly for children. The safety belt 30 may be adjustable and, as desired, retractable, and may be of substantially conventional construction. Where the safety belt 30 is retractable, the retraction mechanism may be located within the lid 14.

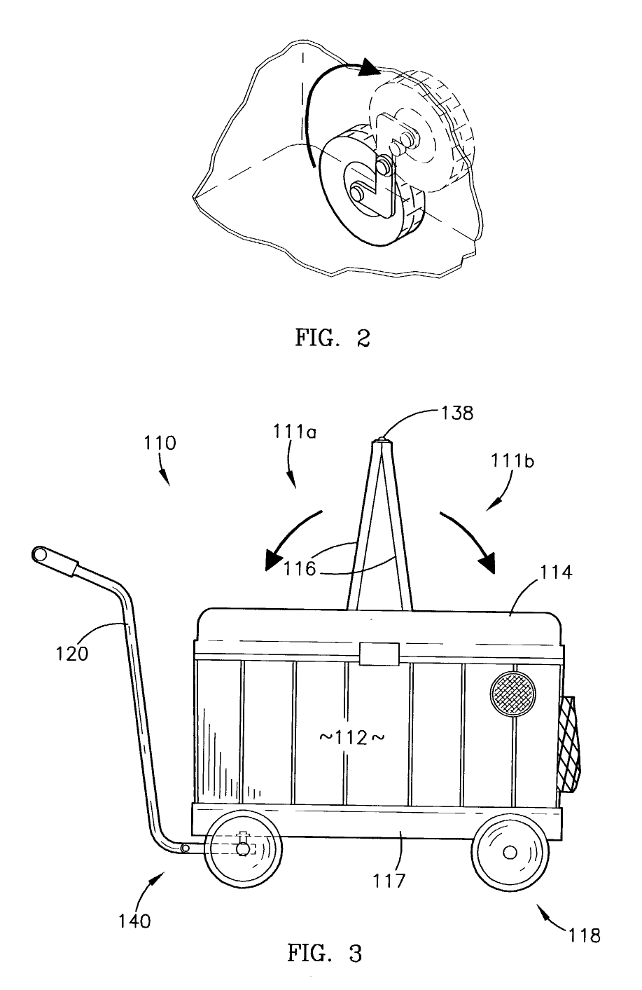

The two or more wheels 18 are physically associated with and adapted to support the body 12 and to allow for wheeled movement of the cooler 10. Referring also to FIG. 2, to facilitate storage and transportation of the cooler 10, the wheels 18 may be pivotably coupled with body 12 so as to be positionable in a first wheel position wherein the wheels 18 project below and support the body 12, and a second wheel position wherein the wheels 18 do not project below and do not support the body 12. Alternatively, the wheels 18 may be completely separable from the body 12 for efficient storage and transportation. As desired, the cooler 10 may be provided with more than two wheels 18, as is the case, for example, in a preferred second embodiment described below.

The handle 20 is coupled with the body 12 and adapted to facilitate pulling and steering the wheeled cooler 10. As illustrated, the handle 20 is substantially S-shaped, having a lower portion adapted to removably couple with the body 12 to facilitate storage and transportation, and an upper portion positioned at a comfortable height for gripping and pulling or pushing. Where the cooler 10 includes only two wheels 18, the lower portion of the handle 20 may include a downwardly projecting leg 36 adapted to rest upon the ground or other surface beneath the cooler 10 when the cooler 10 is not being moved or otherwise supported by a person, thereby substantially increasing the cooler's stability when at rest. When the cooler 10 is being moved, the handle 20 is slightly lifted such that the downwardly projecting leg 36 does not contact the ground and therefore does not impede movement. The upper portion of the handle 20 may be telescopically adjustable in order to facilitate achieving the comfortable height.

In exemplary use and operation, the backrest 16 is lowered to the second seat position, the wheels 18 are pivoted to the second wheel position, and the handle 20 is collapsed, removed, or folded, whereafter the cooler 10 may be stored and transported in, for example, the trunk of a vehicle. When needed, the cooler 10 is removed from the trunk, the backrest 16 is raised to the first seat position, the wheels 18 are lowered to the first wheel position, and the handle 20 is extended, coupled, or unfolded. A child can then sit on the integral seat 11 and, as desired, the safety belt 30 can be secured about the child.

A person then adjusts the handle 20 to a comfortable position, and grasps and lifts the handle 20 slightly so that the downwardly projecting leg 36 lifts from the ground. The person can then pull or push the cooler 10 and the child seated on the integral seat 11 where desired.

Referring also to FIG. 3, the cooler 110 is shown constructed in accordance with the aforementioned preferred second embodiment which is substantially similar to the preferred first embodiment, but for the following differences. As illustrated, the cooler 110 broadly comprises the cooler body 112; the cooler lid 114; two backrests 116a, 116b; a frame 117; four wheels 118; and the handle 120.

The upper surface of the lid 114 presents two of the concavities which combine and cooperate with the two backrests 116a, 116b to provide two integral seats 111a, 111b. The integral seats 111a, 111b are shown oriented back-to-back so that each seated user's legs can project comfortably down a side of the body 112. Furthermore, the backrests 116a, 116b, oriented back-to-back, may be made to contact and support one another, thereby substantially preventing overextension or other damage to the backrests 116a, 116b. A latch 138 or similar mechanism may be used to selectively couple the contacting backrests 116a, 116b.

The frame 117 provides a mechanism for removably associating the wheels 118 and the handle 120 with the body 112 and provides additional structural support for the additional weight of the two users. Preferably, the body 112 is positioned upon and secured to the frame 117 for use, and removed therefrom for storage and transportation. Alternatively, the body 112 and frame 117 may be integrated and non-separable.

A forward portion 140 of the frame 117 couples two of the wheels 118 and the handle 120 in a pivotable relationship with the remainder of the frame 117, thereby facilitating steering the cooler 110. This feature is particularly advantageous in this second preferred embodiment because of the increased size and weight of the fully-loaded two-seat cooler 110.

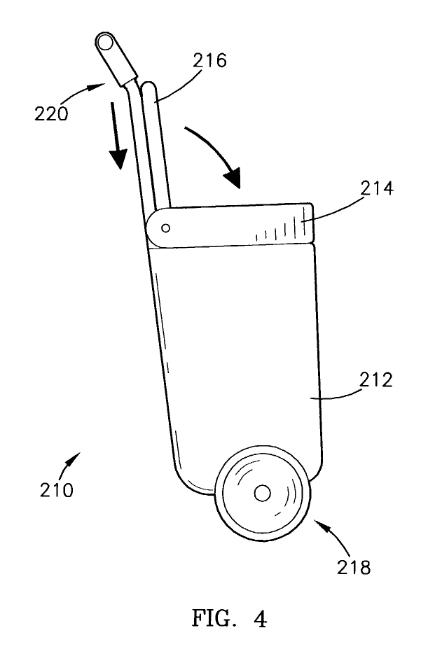

Referring also to FIG. 4, the cooler 210 is shown constructed in accordance with a preferred third embodiment which is substantially similar to the preferred first embodiment, but for the following differences. The cooler 210 is configured to be substantially smaller and more compact than previous embodiments, resembling, in certain respects, conventional wheeled luggage. As illustrated, the cooler 210 broadly comprises the cooler body 212; the cooler lid 214; the backrest 216; two wheels 218; and the handle 220. The handle 220 is telescopically extendable along one side of the body 212. The backrest 216, in the first seat position, rests against the extended handle 220. The cooler 210 may be pulled or pushed, as desired.

When not in use, the backrest 216 folds into the second seat position so as to be substantially flush with the upper surface of the lid 214, and the handle 220 telescopically collapses so as to be flush with the lid 214 and close against the body 212, thereby facilitating storage in small spaces (e.g., under a seat or chair).

From the preceding description, it will be appreciated that the various preferred embodiments of the cooler 10 of the present invention provide a number of substantial advantages over the prior art, including, for example, providing one or more integral seats 11 adapted to comfortably and safely accommodate a child or adult, wherein such adaptation includes structural and ergonomic enhancements which make the cooler 10 more comfortable and safer to sit upon than prior art coolers. Furthermore, the cooler 10 includes two or more wheels 18 which allow it to retain its portable nature even while being sat upon. Additionally, certain components of the cooler 10 can be removable, collapsible, or otherwise stowable to facilitate convenient storage and transport of the cooler 10. Additionally, the cooler 10 includes safety reflectors 23 which advantageously enhance safety, particularly during evening or other low-light use. Additionally, the cooler 10 includes one or more elastically expandable pouches 24 adapted to conveniently receive and store items in close association with the cooler 10.

Although the invention has been described with reference to the preferred embodiments illustrated in the attached drawings, it is noted that equivalents may be employed and substitutions made herein without departing from the scope of the invention as recited in the claims. For example, specific features shown or otherwise associated with a particular one of the preferred embodiments can be readily adapted for use with another preferred embodiment.

Having thus described the preferred embodiment of the invention, what is claimed as new and desired to be protected by Letters Patent includes the following:

1. A cooler comprising:
a cooler body having an insulated compartment;
a cooler lid adapted to cooperate with the cooler body so as to substantially seal the insulated compartment, with an upper surface of the lid having a concavity; and
a backrest movably coupled with the upper surface of the lid adjacent the concavity,
wherein the concavity and the backrest combine and cooperate to form a seat.

2. The cooler as set forth in claim 1, wherein the concavity is ergonomically contoured for comfort.

3. The cooler as set forth in claim 1, further including a safety belt attached to the lid and adapted to secure about a person sitting on the seat.

4. The cooler as set forth in claim 1, wherein the backrest is hingedly coupled with the upper surface of the lid so as to be positionable in a first seat position wherein the backrest is at least perpendicular to the upper surface of the lid, and a second seat position wherein the lid is substantially parallel to the upper surface of the lid.

5. The cooler as set forth in claim 4, wherein, in the second seat position, at least a portion of the backrest is received within the concavity.

6. The cooler as set forth in claim 1, further including a safety belt attached to the backrest and adapted to secure about a person sitting on the seat.

7. The cooler as set forth in claim 1, further including two or more wheels physically associated with the cooler body and adapted to support and allow for wheeled movement of the cooler.

8. The cooler as set forth in claim 7, wherein the two or more wheels are separable from the cooler body.

9. The cooler as set forth in claim 7, wherein the two or more wheels are pivotably coupled with the cooler body so as to be positionable in a first wheel position wherein the two or more wheels project below and support the cooler body, and a second wheel position wherein the two or more wheels do not project below and do not support the cooler body.

10. The cooler as set forth in claim 7, further including a handle coupled with the cooler body and adapted to facilitate pulling and steering the cooler.

11. The cooler as set forth in claim 10, wherein the handle is telescopically extendable.

12. The cooler as set forth in claim 7, further including a frame to which the two or more wheels are coupled and on which the cooler body can be removably placed.

13. The cooler as set forth in claim 1, further including one or more safety reflectors attached to the cooler body.

14. The cooler as set forth in claim 1, further including an expandable pouch attached to a side of the cooler body and adapted for receiving and retaining one or more items.

15. A cooler comprising:
a cooler body having an insulated compartment;
a cooler lid adapted to cooperate with the cooler body so as to substantially seal the insulated compartment, with an upper surface of the lid having an ergonomically contoured concavity;
a backrest movably coupled with the upper surface of the lid adjacent the concavity, wherein the backrest is hingedly coupled with the upper surface of the lid so as to be positionable in a first seat position wherein the backrest is at least perpendicular to the upper surface of the lid, and a second seat position wherein the lid is substantially parallel to the upper surface of the lid, wherein the concavity and the backrest combine and cooperate to form a seat;
two or more wheels physically associated with the cooler body and adapted to support and allow for wheeled movement of the cooler; and
a handle physically associated with the cooler body and adapted to facilitate pulling and steering the cooler.

16. The cooler as set forth in claim 15, wherein the two or more wheels are pivotably coupled with the cooler body so as to be positionable in a first wheel position wherein the two or more wheels project below and support the cooler body, and a second wheel position wherein the two or more wheels do not project below and do not support the cooler body.

17. The cooler as set forth in claim 15, further including a safety belt adapted to secure about a person sitting on the seat.

18. The cooler as set forth in claim 15, further including one or more safety reflectors attached to the cooler body.

19. The cooler as set forth in claim 15, further including an expandable pouch attached to a side of the cooler body and adapted for receiving and retaining one or more items.
